(19) United States
(12) Patent Application Publication
(10) Pub. No.: US 2022/0371956 A1
(43) Pub. Date: Nov. 24, 2022

(54) PRODUCTION PROCESS OF ARTIFICIAL AGGREGATE FROM TAILINGS FROM MINING, ARTIFICIAL AGGREGATE, CONCRETE COMPOSITION AND USE

(71) Applicants: VALE S.A., Rio de Janeiro (BR); FUNDAÇÃO DE AMPARO À PESQUISA DO ESTADO DE MINAS GERAIS - FAPEMIG, Belo Horizonte (BR); UNIVERSIDADE FEDERAL DE MINAS GERAIS - UFMG, Belo Horizonte (BR)

(72) Inventors: Evandro Moraes DA GAMA, Belo Horizonte (BR); Larissa Virgínia Queiroz FAGUNDES, Pedro Leopoldo (BR); Abdias Magalhães GOMES, Belo Horizonte (BR)

(21) Appl. No.: 17/772,486

(22) PCT Filed: Oct. 30, 2020
(86) PCT No.: PCT/BR2020/050444

§ 371 Date: Apr. 27, 2022

(30) Foreign Application Priority Data
Oct. 30, 2019 (BR) BR1020190227249

(51) Int. Cl. C04B 18/12; C04B 18/02; C04B 7/12; C04B 7/52; C04B 14/06

(52) U.S. Cl. CPC C04B 18/12; C04B 18/021; C04B 7/12; C04B 7/525; C04B 14/062; C04B 2111/00017

(57) ABSTRACT

The present invention relates to the process of producing artificial aggregate from tailings from ore dams. The iron ore sandy tailings are mixed with a binder and, through the mixing and pelletizing process, form the artificial aggregate. The artificial aggregate produced has a spheroidal shape, a large size, a rough surface and a color that ranges between pink and dark red. This artificial aggregate is able to replace the natural aggregate, and can be used in the manufacture of a more resistant concrete, for the base and sub-base of roads, as a decorative element for gardens and beds, in addition to being a form of storage of ore dam tailings in the form of pellets, adding value to these tailings and reducing the environmental mining impacts.

### TECHNICAL FIELD

The present invention relates to the process of producing artificial aggregate from tailings from ore dams. The iron ore sandy tailings are mixed with a binder and, through the mixing and pelletizing process, form the artificial aggregate. The artificial aggregate produced has a spheroidal shape, a large size, a rough surface and a color that ranges between pink and dark red. This artificial aggregate is able to replace the natural aggregate, and can be used in the manufacture of a more resistant concrete, for the base and sub-base of roads, as a decorative element for gardens and beds, in addition to being a form of storage of ore dam tailings in the form of pellets, adding value to these tailings and reducing the environmental mining impacts.

State of Art

The aggregates for civil construction and for base and sub-base of roads are usually natural, coming from gneiss quarries, granites and limestones, among other rocks. These quarries are exploited by federal mineral concessions. The exploitation of these rocks within large cities is not allowed, as it generates environmental problems in the vicinity of urban communities. In the case of roads, the exploitation of these minerals along the route of the road requires permits. Thus, the production of natural aggregate is costly and complex, requires obtaining licenses and involves drilling, dismantling, crushing, sieving and washing.

Iron ore tailings are residues remaining from the beneficiation process and concentration of ores in industrial facilities. Due to the type of ore and the differences in the mineral beneficiation process, the tailings have a wide variety in their features, such as: particle size, mineralogy, density and particle shape. Thus, the properties of iron ore tailings can range, from materials with very fine particle size and high plasticity to non-plastic materials with sandy features (MACHADO, W. G. F. (2007). Monitoramento de Barragens de Contença̋o de Rejeitos da Mineraça̋o. Master's Thesis. Escola Politécnica da Universidade de Sa̋o Paulo, Sao Paulo. 155p).

Mining tailings are applied as raw material for civil construction, in the concrete production. Franco et al. used the mud from iron ore dams as an artificial aggregate to replace the natural fine aggregate used in concrete, in the percentages of 0.5%, 5%, 10% and 50% (FRANCO, L. C. et al. Aplicaça̋o de rejeito de mineraça̋o como agregado para a produa̋a̋o de concreto. 2014. 56° Congresso Brasileiro do Concreto—Natal/RN. Ed.: IBRACON. ISSN.:2175-8182. Portuguese, p. 561 2014).

Iron ore tailings can be used as fine aggregates because they are relatively inert and because the particle size is significantly larger than that of the cement. However, iron ore tailings have the potential to replace natural sand as fine aggregate, being a cheaper and environmentally friendly alternative (ZHAO, S.; FAN, J.; SUN, W. Utilization of iron ore tailing as fine aggregate in ultra-high performance concrete. Construction and Building Materials, v 50, p 540-548. 2014; (HUANG, X.; RANADE, R.; NI, W.; LI, V.C. Development of Green engineered cementitious composites using iron ore tailigs as aggregates. Construction and Building Materials, v 44, p 757-764).

Strategies based on the use of tailings from iron ore dams as raw material are in the state of the art in order to minimize environmental impacts resulting from the exploitation of natural materials and engineering works.

Patent application BR1020130312606, entitled “Use of tailings from iron ore dams as raw material for construction of road infrastructure” reports a method of applying iron ore tailings as raw material for construction of road infrastructure and urban roads through a mixture composed of tailings and hydraulic binder, pozzolan, lime, slag, cement, among others. However, this method involves physical mixing and mechanical compaction, either by chemical actions of hardening of the mixtures, or by mechanical compaction energy or by a combination of these.

There are other technologies in the state of the art that deal with artificial aggregates for application on concretes or roads, especially aggregates formed by industrial waste materials or construction tailings to reduce disposal costs and environmental load of industrial waste. Among these, the following stand out.

KR101631276, entitled “Manufacturing method of recycled aggregates using bauxite residue,” describes a rigid artificial aggregate that can show a fixed level of strength through a solidification process of a mixture composed of residual bauxite, cement, an additive composed of a solidifying agent, and an inorganic binder, which can be applied as drainage material or the like to the soil improvement process.

JP2005104804, entitled “Artificial Aggregate”, presents an artificial aggregate material formed by heating and sintering a molded body comprising coal ash, aluminum ash, cement and water, for use in the production of concrete and sidewalk material.

JP2008137842, entitled “Method of manufacturing artificial aggregate using construction waste,” presents a method of manufacturing an artificial aggregate using construction waste, such as glass, debris, and concrete, generated from demolished buildings. Such residues are mixed with cement and water, and are subjected to the granulation process.

Thus, the state of the art comprises artificial aggregates with applications that stop only as constructive elements manufactured from civil construction waste or industrial waste such as residual bauxite and coal ash. The citation employing tailings from iron ore dams as raw material for road infrastructure construction is related to a compacted mixture at the road site, a mass composed of various inputs that is tight or compacted. In the state of the art, there is no technique capable of using tailings from iron ore dams as raw material for the manufacture of an aggregate capable of being used a posteriori in applications such as civil construction.

The present invention describes an artificial aggregate obtained from tailings from iron ore dams composed of fine sandy tailings and binder such as cement or pozzolan, which are mixed and pelletized, giving spheroidal shape to the product, which has a coarse size (from 4.8 to 16 mm), rough surface and coloration ranging from pink to dark red, having physical properties suitable for use in applications such as civil construction, sub-base of roads, storage of dam tailings in the form of pellets, decorative element for gardens and flower beds. It also describes an efficient and effective process for the manufacture of said artificial aggregate from tailings from iron ore dams and a concrete composition for civil construction using said artificial aggregate as partial substituent of the natural gravel. The artificial aggregate is able to replace the natural aggregate (gravel) in the concrete, leading the concrete to have compatible strength when using the natural aggregate (axial compression resistance—NBR 5739: 2007).

### BRIEF DESCRIPTION OF THE FIGURES

FIG. 1 illustrates a flowchart of the production process of the artificial aggregate from mining sandy tailings proposed by the present invention.

FIG. 2 shows an artificial aggregate pellet, produced according to the process described in the present invention.

FIG. 3 shows the concrete mortars in standard form with natural aggregate and mixtures I and III.

### DETAILED DESCRIPTION OF THE INVENTION

The present invention relates to the process of producing artificial aggregate from tailings from ore dams. The iron ore sandy tailings are mixed with a binder and, through the mixing and pelletizing process, form the artificial aggregate. The artificial aggregate produced has a spheroidal shape, a large size, a rough surface and a color that ranges between pink and dark red. This artificial aggregate is able to replace the natural aggregate, and can be used in the manufacture of a more resistant concrete, for the base and sub-base of roads, as a decorative element for gardens and beds, in addition to being a form of storage of ore dam tailings in the form of pellets, adding value to these tailings and reducing the environmental mining impacts.

The artificial aggregate production process is carried out at room temperature and covers the following steps:
a. Providing a sandy mining tailings with particle size from 0.03 to 11 mm;
b. Mixing the sandy tailings and a binder wherein the mixture composition has 65 to 85% by weight mining tailings and 15 to 35% by weight binder, for approximately 30 to 60 minutes until the mixture is homogeneous;
c. Pelletizing the mixture at room temperature in a pelletizing machine by adding water in a sprayed manner;
d. Curing the pellets at room temperature for a period ranging from 1 to 14 days.

The mining tailings mentioned in step “a” may be a fine sandy tailings coming from iron ore dams and containing the minerals Goethite, Hematite, Quartz, Kaolinite and preferably also Gibbsite.

If the sandy tailings has a moisture content of less than 20%, the mixture must be made in continuous mixers with the following preferred features: mixing chamber with diaphragm for flow adjustment, central rotor, blade-type mixing utensils and side scrapers. The rotation ranges from 10 to 45 rpm, according to the homogeneity of the water in the mixture.

If the sandy tailings have moisture greater than 20% by weight, it will need to go through a drying process prior to mixing and pelletizing, that is, after step “a”. The drying process may be natural or in a rotary dryer used to dry river dredging sand. After drying, the sandy tailings can be mixed with the binder in a mixer, according to step “b” or, alternatively, it can be mixed with the binder in a pelletizer disc with adjustable edges, being added at the same time.

The binder mentioned in step “b” may be commercial pozzolan or pozzolan produced with the mining sterile itself after calcination of the sterile.

The binder may be pozzolan obtained from the sterile iron mining calcined by flash technology from 750 to 950° C., and mixed with Portland CPV cement in the mass ratio of 25 to 30% by weight of the calcined sterile and 70 to 75% by weight of Portland CPV cement.

In step “c”, the pelletizing machine should preferably have an adjustable height edge. The rotation must be from 10 to 25 rpm, using a disk inclination from 40 and 50°, for a period of time from 30 and 70 minutes, considering a mass of 400 kg. The pelletizing is carried out at room temperature. During the pelletizing process of step “c”, water is continuously sprayed when the moisture of the mixture is below 8%. The optimal humidity for pellet formation ranges from 4 to 12%.

Finally, as described in step “d”, the pellets must be cured at room temperature for a period of 1 day to 14 days.

The artificial aggregate, obtained through the process described above, is composed of 65 to 85% by weight of mining tailings and 15 to 35% by weight of binder, which are mixed and pelletized, giving spheroidal shape to the product, which has a large size (from 4.8 to 16 mm), rough surface, color varying between pink and dark red and preferably diameter varying between gravel 0 (B0:−12.5 mm+4.8 mm), 00 gravel (B00: −9.5 mm+4.8 mm) or B0/B1 gravel (B0/B1: −16 mm+9.5 mm).

The artificial aggregate based on tailings from ore dams can be used in the manufacture of concrete, for the base and sub-base of roads; storage of dam tailings in the form of pellets; or decorative element for gardens and beds.

The present invention further proposes a concrete composition employing artificial aggregate comprising:

15.2 to 18.6% by weight of Portland cement;

32.8 to 34.3% by weight of natural sand;

48.5 to 50.4% by weight of aggregate (only artificial or artificial and natural together).

The composition percentages refer to the percentage by mass considering the dry basis. To obtain the concrete, water must be added to the composition.

The concrete composition employing artificial aggregate may contain only the artificial aggregate or may contain the artificial aggregate together with the natural aggregate (gravel).

Within the composition of the concrete employing artificial aggregate, the weight percent of the aggregate can be divided between 25.2% by weight of B0/B1 gravel (B0/B1: −16 mm+9.5 mm) and 25.2% by weight of gravel 0 (B0: −12.5 mm+4.8 mm), or 24.3% by weight of B0/B1 gravel (B0/B1: −16 mm+9.5 mm) and 24.3% by weight of gravel 0 (B0:−12.5 mm+4.8 mm); or 12.1% by weight of 00 gravel (B00: −9.5 mm+4.8 mm) and 36.4% by weight of gravel 0 (B0: −12.5 mm+4.8 mm).

The treated matter may be better understood from the following examples, without limiting the scope of the invention.

### EXAMPLE 1— Artificial Aggregate Production Process

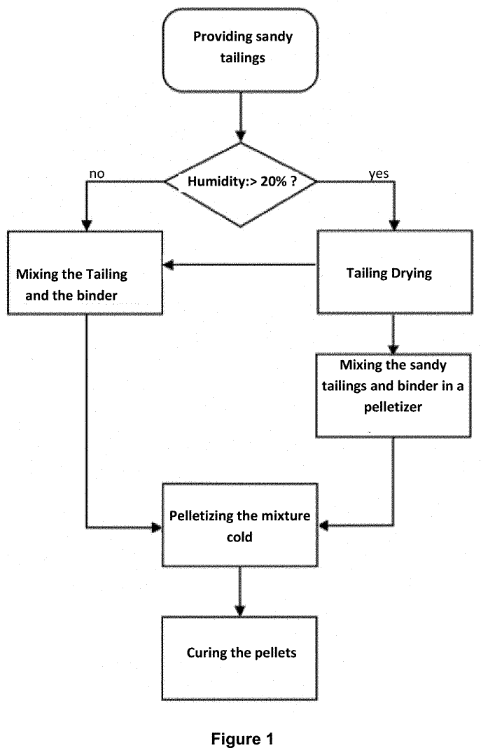

The process of obtaining the artificial aggregate was performed as shown in FIG. 1. The sandy tailings of iron ore mixed with a binder provides, through a process of mixing and pelletizing at room temperature, the formation of artificial aggregate material capable of replacing the coarse natural aggregate, providing mechanical resistance to concrete, compatible with the Brazilian standard NBR 5759.

The sandy tailings present in iron ore dams have a particle size from 0.03 to 11 mm. Its mineralogical composition is quite variable in percentage, but the type of mineral is constant, composed of silicon and iron minerals.

Table 1 presents mineralogical compositions of tailings samples obtained in iron ore dams. It is noted that the present invention has a special interest in using the ore dam tailings, mainly the fine sandy tailings containing the minerals Goethite, Hematite, Quartz, Kaolinite and preferably also Gibbsite, but other tailings with suitable features can also be used.

TABLE 1
Percentage of mineral components of iron ore dam tailings

| Sample | Goethite | Hematite | Quartz | Gibbsite | Kaolinite |
|---|---|---|---|---|---|
| Waste 1 | 48.0 | 21.3 | 16.7 | 2.7 | 11.3 |
| Waste 2 | 20.1 | 48.0 | 25.0 | — | 6.9 |
| Waste 3 | 22.5 | 23.0 | 42.0 | — | 12.5 |

The manufacturing process of the artificial aggregate begins with the mixture of 65 to 75% of sandy tailings (fine to medium granulometry) of iron ore dams with 25 to 35% of binder.

If the sandy tailings has a moisture content of less than 20%, the mixture must be made in continuous mixers with the following preferred features: mixing chamber with diaphragm for flow adjustment, central rotor, blade-type mixing utensils and side scrapers. The rotation ranges from 10 to 45 rpm, according to the homogeneity of the water in the mixture.

If the dam sandy tailings contains more than 20% moisture, it must undergo a drying process. The process may be natural or in a rotary dryer used to dry river dredging sand. Mixer is not required in this case. Preferably, the dam sandy tailings after drying enters a pelletizer disc with adjustable edges at the same time as the binder.

The binder must be a commercial pozzolan or produced with the mining sterile itself after calcination of the sterile. The iron mine sterile must be calcined with flash technology from 750 to 950° C. The mixtures of the calcined sterile with CPV cement, entitled binders, must be in the proportion by mass of 25 to 30% of calcined sterile and 70 to 75% by weight of Portland CPV cement.

In the next step, the homogenized mixture is poured into a pelletizing machine with adjustable height edge. The rotation and inclination of the pelletizer disc with adjustable edge must be from 10 to 25 rpm, and the inclination from 40 to 50°. The residence time of the mixture in the pelletizer ranges from 30 to 70 minutes, considering a mass of 400 kg. The pelletization is carried out at room temperature, that is, there are no subsequent stages of burning the pellets.

During the pelletizing process, water is continuously sprayed when the moisture of the mixture is below 8%. The optimal humidity for pellet formation ranges from 4 to 12%.

The resulting product is pellets of approximately spherical shape, rough surface, large size and coloration ranging from pink to dark red, which will be used as an artificial aggregate. The bulk density is from 1800 to 2000 kg/m³.

The diameter of the pellets may preferably vary between gravel 0 (B0: −12.5 mm+4.8 mm), 00 gravel (B00: −9.5 mm+4.8 mm) or B0/B1 gravel (B0/B1 : −16 mm+9.5 mm).

After the pelletizing process, the pellets must undergo a curing process at room temperature. The curing time for the pellets to have adequate mechanical strength ranges from 24 hours to 21 days, depending on the diameter manufactured and the desired use.

### EXAMPLE 2— Uses of Artificial Aggregate

The artificial aggregate based on tailings from ore dams can be used in the manufacture of concrete, for the base and sub-base of roads; storage of dam tailings in the form of pellets; or decorative element for gardens and beds.

The concrete composition using the artificial aggregate proposed in the present invention comprises 15.2 to 18.6% by weight Portland cement; 32.8 to 34.3% by weight natural sand; 48.5 to 50.4% by weight aggregate (only the artificial or artificial and natural together).

To obtain the concrete, water must be added to the composition.

In this concrete composition, the weight percent of the aggregate is divided between 25.2% by weight of gravel B0/B1(B0/B1: −16 mm+9.5 mm) and 25.2% by weight of gravel 0 (B0: −12.5 mm+4.8 mm); or 24.3% by weight of B0/B1 gravel (B0/B1: −16 mm+9.5 mm) and 24.3% by weight of gravel 0 (B0: −12.5 mm+4.8 mm); or 12.1% by weight of 00 gravel (B00: −9.5 mm+4.8 mm) and 36.4% by weight of gravel 0 (B0: −12.5 mm+4.8 mm).

The present artificial aggregate technology, applied in concrete, may replace the natural aggregate (gravel) or may be used in conjunction with the natural aggregate. Natural aggregate does not have a chemical affinity with cement and concrete (thixotropy). On the other hand, artificial aggregate improves concrete strength due to surface roughness.

In road construction, the artificial aggregate from tailings from dams can be used to compose the base and sub-base. The use must be made by mixing the artificial aggregate in the soil and then processing the compaction according to current technical standards.

The spherical shape of the artificial aggregate provides greater mechanical strength in addition to better storage, as it allows drainage between the spheres through the empty spaces when arranged in piles or stored in open patios subject to rain.

Mining dams usually store mud (mining tailings with very fine grain size) and sand with water, which makes the set unstable with the possibility of rupture. Artificial aggregate may be stored within this location or busbar without the need for water, or in storage stacks in storage yards. Subsequently, the artificial aggregate can be used as aggregate for concrete, base and sub-base construction element for roads or even ornamental element of gardens and beds.

This technology has the advantage of mobilizing environmental liabilities efficiently and economically, adding value to mining tailings. In addition, it provides ease of storage because it is a spherical and inert material and, due to its water absorption capacity, favors the humidity of the environment, which benefits the applications of the artificial aggregate in gardens and beds.

### EXAMPLE 3— Compressive Strength Test

The results of compressive strength as a function of the curing time of the artificial aggregate are shown in Table 2. The axial compression strength test followed the methodology and normative prescriptions described in NBR 5739/2007. The results in Table 2 show an evolution of the strength of the artificial aggregate with curing time. This evolution reaches 100% of the resistance of a limestone gravel.

TABLE 2
Compressive strength as a function of curing time

| Curing time (day) | | | | | | | |
|---|---|---|---|---|---|---|---|
| 0 | 1 | 2 | 3 | 6 | 7 | 14 | 31 |

Resistance (Kgf/pellet)—12.5 mm + 9.5 mm

| | | | | | | | | |
|---|---|---|---|---|---|---|---|---|
| Average | 1.40 | 3.12 | 7.83 | 12.35 | 14.80 | 17.50 | 18.80 | 15.50 |
| resistance | | | | | | | | |
| % in relation | 9.0 | 20.1 | 50.5 | 79.7 | 95.5 | 112.9 | 121.3 | 100.0 |
| to 29 days | | | | | | | | |

Resistance (Kgf/pellet)—16 mm to 12.5 mm

| | | | | | | | | |
|---|---|---|---|---|---|---|---|---|
| Average | 2.32 | 4.85 | 10.54 | 17.17 | 23.40 | 25.40 | 27.30 | 26.80 |
| resistance | | | | | | | | |
| % in relation | 8.7 | 18.1 | 39.3 | 64.1 | 87.3 | 94.8 | 101.9 | 100.0 |
| to 29 days | | | | | | | | |

Resistance (Kgf/pellet)—19 mm to 1 mm

| | | | | | | | | |
|---|---|---|---|---|---|---|---|---|
| Average | 3.77 | 7.10 | 14.53 | 21.03 | 31.40 | 28.70 | 42.20 | 51.30 |
| resistance | | | | | | | | |
| % in relation | 7.3 | 13.8 | 28.3 | 41.0 | 61.2 | 55.9 | 82.3 | 100.0 |
| to 29 days | | | | | | | | |

Evolution of compressive strength overtime, considering the final
resistance of 29 days

| | | | | | | | | |
|---|---|---|---|---|---|---|---|---|
| % average | 8.3 | 17.4 | 39.4 | 61.6 | 81.3 | 87.9 | 101.8 | 100.0 |
| over | | | | | | | | |
| resistance | | | | | | | | |
| 29 days | | | | | | | | |

It is observed that the preferred cure time is 14 days.

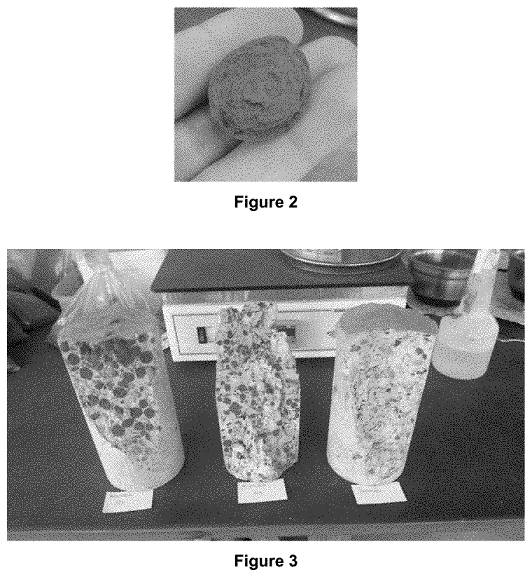

FIG. 2 shows the aspect of a pellet obtained by the process of the present invention. It can be observed that, from the center to the edge, the layers that form are concentric, being a skeleton for resistance. It is noted that the pellets have very low porosity, that is, they do not absorb water or dissolve when immersed. The bulk density is from 1800 to 2000 Kg/m³.

### EXAMPLE 3— Compressive Strength Tests on Concrete Mortars

For the molding and curing procedure of the concrete using the artificial aggregate, the methodology and normative rules described in NBR 5738/2003 were used. FIG. 3 shows the appearance of concrete mortars in standard form with natural aggregate and with mixtures I and III.

Concrete mortars were obtained in a standard way and in different mixtures with the artificial aggregate, according to the dosages presented in Table 3.

TABLE 3
Dosage of materials for obtaining standard concrete mortars and mixing with artificial aggregate

| | % by mass (dry basis) | | | |
|---|---|---|---|---|
| Raw material | Standard (%) | Mixture I (%) | Mixture II (%) | Mixture III (%) |
| CPV cement | 16.7 | 15.2 | 18.5 | 18.6 |
| Natural sand | 27.8 | 34.3 | 33 | 32.8 |
| Artificial aggregate (B₀/B₁) | — | 25.2 | 24.3 | — |
| Artificial Aggregate (B₀₀) | — | — | — | 12.1 |
| Natural Aggregate (B₀) | 55.5 | 25.2 | 24.3 | 36.4 |
| Water (Liters) | 4.25 | 5 | 5.4 | 5.3 |

The mortar compression test was followed by the normative methodology and prescription described in NBR 5739/2007— Concrete—Compression test of cylindrical specimens. The results of its resistance in relation to the standard are listed in Table 4.

TABLE 4
Compressive strength in relation to the standard.

| | Compressive strength relative to standard (%) | | |
|---|---|---|---|
| Sample | 12 days | 17 days | 28 days |
| Mixture I | 65.8 | 51.6 | 53.2 |
| Mixture II | 79.5 | 65.8 | 82.5 |
| Mixture III | 99.1 | 99.4 | 101.0 |

The resistance of the mixtures where the artificial aggregate is used is at least 51.6% of the resistance of the same mortar, when using the natural aggregate, having reached the standard resistance.

Several variations focusing on the scope of protection of the present invention are permitted. The artificial aggregate of the present invention has a special application to replace natural aggregates in the concrete composition.

However, the artificial aggregate of the present invention can be used in the most diverse applications, such as base and sub-base constructive element for roads, tailings storage in dams in the form of pellets, as well as decorative element in gardens and beds. Thus, it is emphasized the fact that the present invention is not limited to the particular configurations/embodiments described above.

1. An artificial aggregate production process,
comprising:
(a) a providing sandy mining tailings, arranged in ore dams, with a particle size of between 0.03 and 11 mm;
(b) mixing the sandy mining tailings and a binder for 30 to 60 minutes until a mixture thereof is homogeneous, wherein the binder comprises commercial pozzolan or pozzolan produced from mining sterile itself after calcination thereof mixed with CPV Portland cement, and wherein the sandy mining tailings and binder mixture has 65 to 85% by weight sandy mining tailings and 15 to 35% by weight binder;
(c) pelletizing the mixture at room temperature in a pelletizing machine to form pellets, wherein forming the pellets comprises adding water sparged to a humidity of from 4 and 12% to the pelletizing machine, and wherein a residence time of the mixture in the pelletizing machine ranges from 30 to 70 minutes, considering a mass of 400 kg of the mixture; and
(d) curing the pellets at room temperature for a period ranging from 1 to 14 days;
wherein calcining the mining sterile of step (b) is conducted with flash technology at from 750 and 950° C. and the binder comprises a mass ratio of 25 to 30% of calcined mining sterile and 70 to 75% by weight of CPV Portland cement.

2. The artificial aggregate production process of claim 1, wherein the sandy mining tailings contain Goethite, Hematite, Quartz and Kaolinite, and optionally Gibbsite.

3. The artificial aggregate production process of claim 1, wherein the sandy mining tailings are dried after step (a) if the sandy mining tailings have a moisture content greater than 20% by weight.

4. The artificial aggregate production process of claim 3, wherein the drying of the sandy mining tailings is natural or in a rotary dryer used to dry river dredging sand.

5. The artificial aggregate production process of according to claim 1, wherein the mixing of step (b) is performed in continuous mixers if the sandy mining tailings have a has moisture content of less than 20%, the continuous mixers having a mixing chamber with a diaphragm for flow adjustment, a central rotor, paddle-type mixing utensils, and side scrapers, and wherein a rotation of the central rotor ranges from 10 to 45 rpm.

6. The artificial aggregate production process of according to claim 1, wherein the mixing of step (b) is performed in a pelletizer disc with adjustable edges, the sandy mining tailings and the binder being added at a same time, if the sandy mining tailings has have a moisture content of greater than 20%.

7. The artificial aggregate production process of according to claim 1, wherein the pelletizing machine has an adjustable height edge, with rotation from 10 to 25 rpm, disk inclination from 40 to 50°, for a period of time from 30 to 70 minutes.

8. An artificial aggregate obtained by the process of claim 1, wherein the artificial aggregate comprises 65 to 85% by weight sandy mining tailings and 15 to 35% by weight binder.

9. The artificial aggregate of claim 8, wherein the artificial aggregate has a color ranging between pink and dark red, a spherical shape, a size from 4.8 to 16 mm, a rough surface and a diameter ranging between gravel 0 (B0: −12.5 mm+4.8 mm), 00 gravel (B00: −9.5 mm+4.8 mm) and B0/B1 gravel (B0/B1: −16 mm+9.5 mm).

10. A concrete composition comprising:
15.2 to 18.6% by weight of Portland cement;
32.8 to 34.3% by weight of natural sand;
48.5 to 50.4% by weight of the artificial aggregate of claim 8.

11. The concrete composition of claim 10, wherein the concrete composition comprises natural aggregate with the artificial aggregate.

12. The concrete composition of claim 10, wherein a weight percentage of the artificial aggregate is divided between 25.2% by weight of gravel B0/B1(B0/B1: −16 mm+9.5 mm) and 25.2% by weight of gravel 0 (B0: −12.5 mm+4.8 mm); or 24.3% by weight of B0/B1 gravel (B0/B1: −16 mm+9.5 mm) and 24.3% by weight of gravel 0 (B0: −12.5 mm+4.8 mm); or 12.1% by weight of 00 gravel (B00: −9.5 mm+4.8 mm) and 36.4% by weight of gravel 0 (B0: −12.5 mm+4.8 mm).

13. A method for manufacturing concrete comprising providing the artificial aggregate of claim 8 and manufacturing concrete therefrom, wherein the concrete is useable as a base and sub-base constructive element for roads, for storage of dam tailings in the form of pellets, or as a decorative element in gardens and beds.

14. (canceled)

15. (canceled)
